(19) United States
(12) Patent Application Publication
(10) Pub. No.: US 2007/0100673 A1
(43) Pub. Date: May 3, 2007

(54) MATRIX methodology for modeling a business intelligence system based on individual life cycles within a business process

(76) Inventor: Srinivas Konakalla, Cupertino, CA (US)

Correspondence Address: Evergreen Valley Law Group, Suite 275, 2670 S. White Road, San Jose, CA, 95148, US

(21) Appl. No.: 11/185,212

(22) Filed: Oct. 31, 2005

(51) Int. Cl. G06F 9/44

(52) U.S. Cl. 705/7

(57) ABSTRACT

The present invention relates to a matrix methodology used for modeling a comprehensive Business Intelligence system based on a business process lifecycle approach that comprises of the steps of: modeling, building, generating and analyzing in order to analyze a business process end to end. In accordance with the present invention, modeling comprises the steps of defining a business process life cycle and its metrics and splitting each Business process lifecycle into several events or stages. This step also includes facilitating gathering of business requirements and developing a project plan based on them.

### BACKGROUND OF THE INVENTION

1. Field of the Invention

The invention relates generally to the field of business intelligence systems. More particularly, this invention relates to a MATRIX methodology for modeling a business intelligence system based on individual life cycles comprising a business process.

2. Description of Related Art

Over the past two decades companies have invested heavily in automating their business and processes by implementing ERP, CRM, BPM and other enterprise software applications to gain competitive edge. These applications have improved the productivity of the companies resulting in reduced costs and gaining competitive edge. However, most companies have implemented these applications resulting in less differentiation between companies. So, the next step in gaining competitive advantage is to improve the business processes by analyzing the data collected in the enterprise software applications and optimizing the business processes.

The present invention relates to structuring business process analysis right from designing and modeling, to integrating and automating, to deploying and executing, and to measuring and optimizing the business process to allow businesses to take control of their data, stay informed and optimize using Business Intelligence methodologies. This invention defines a novel MATRIX methodology that is predicated on breaking up a business process into individual lifecycles and further split the life cycles into individual stages and interlinking these life cycle stages to generate a Business Intelligence system.

### SUMMARY OF THE INVENTION

The present invention relates to a MATRIX methodology used for modeling a comprehensive Business Intelligence system based on a business process lifecycle approach that comprises of the steps of: modeling, building, generating and analyzing in order to analyze a business process end to end. In accordance with the present invention, modeling comprises the steps of defining a business process, splitting the business process into small quantifiable life cycles, further decomposing each business process lifecycle into several events or stages and defining the associated metrics for the lifecycle and stages. This step also includes facilitating gathering of business requirements and developing a project plan based on them.

It is an advantage of the present invention to model a Business Intelligence system that is a comprehensive Business Process Intelligence solution that is derived from blending both Business Process Management and Business Intelligence methodologies.

Another advantage of the present invention is to allow businesses to get a better value from their investments in terms of venerating Business Intelligence solutions.

Another advantage of the present invention is to generate a comprehensive Business Intelligence system that provides improved efficiency for businesses.

Another advantage of the present invention to aid with corporate compliance by generating an end to end visibility of the lowest detail at the corporate level that can assist in Sarbanes Oxley compliance.

It is yet another advantage of the present invention to allow C-Level executives/top management to define and measure the strategic metrics i.e. the life cycle metrics

It is yet another advantage of the present invention to allow operational managers to define and measure operational/tactical metrics that are related to the individual life cycle stages.

It is an objective of the present invention to provide a Business Intelligence system that is a comprehensive Business Process Intelligence solution that is derived from blending both Business Process Management and Business Intelligence.

Another objective of the present invention is to allow businesses to get a better value from their investments in terms of generating Business Intelligence solutions.

Another objective of the present invention is to generate a comprehensive Business Intelligence system that provides improved efficiency for businesses.

Another objective of the present invention to aid with corporate compliance by generating an end to end visibility of the lowest detail at the corporate level that can assist in Sarbanes Oxley compliance.

It is yet another objective of the present invention to allow C-Level executives/top management to define and measure the strategic metrics i.e. the life cycle metrics

It is yet another objective of the present invention to allow operational managers to define and measure operational/tactical metrics that are related to the individual life cycle stages.

### BRIEF DESCRIPTION OF THE DRAWINGS

FIG. 1 is a block diagram illustrating the sequence of steps involved in the generation of a Business Intelligence system within an enterprise.

FIG. 2 is a flow chart illustrating the sequence of steps involved in modeling a business process towards the generation of a comprehensive Business Intelligence system.

FIG. 3 is a flow chart illustrating the sequence of steps involved in translating a business process into building a comprehensive Business Intelligence system.

FIG. 4 is a flow chart illustrating the steps involved in formulating the matrix during the modeling phase in the generation of the Business Intelligence system.

FIG. 5 is a flow chart representation of the series of steps followed during the modeling phase to capture information from executives at the enterprise.

FIG. 6 is a flow chart illustrating the sequence of steps involved in MATRIX methodology illustrating how the business process life cycles and the stages are interconnected.

### DETAILED DESCRIPTION OF THE INVENTION

Business process benchmarking has become a competitive strategic element that affects business partners, individual customers, employee morale, productivity and profitability. Applying Business Intelligence to Business processes and paving paths to Business Process Intelligence has become a determining factor for the success of an organization. The many business processes that run an organization are not isolated systems, but include a maze of small life cycles connected to each other.

Organizational structure throughout the many diverse industries varies but for the most part, all organizations have similar business processes. It is necessary that business and IT users understand the way these processes are, and apply techniques that result in Business Process Intelligence and not just Business Intelligence. Converging Business Intelligence and Business Process helps business analysts continuously and consistently monitor and measure business processes through all phases and with all permutations and combinations. This allows companies to overcome the limitations being posed by creating business intelligence systems that purely based on combing data from disparate sources into one database.

For example there are a number of high level business processes like customer relationship management, supply chain management, production management, financials management and so on, which run a business organization. All these business processes have a number of small quantifiable life cycles to guide the flow of action through a series of activities or stages.

For instance, a business process such as CRM comprises of numerous lifecycles such as Lead to Order, Request to Service etc., The Lead to Order-L20 in turn is made up of Lead, Opportunity, Quote, and Order stages. And the Request to Service-R2S, lifecycle comprises of Switch, Agent/Customer interaction, Customer repair and survey stages.

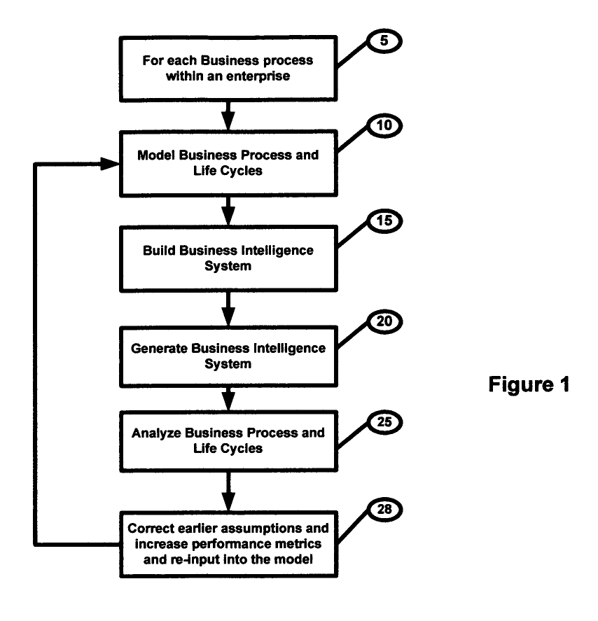

FIG. 1 is a block diagram illustrating the sequence of steps involved in the generation of a Business Intelligence system within an enterprise.

For each business process within an enterprise (step 5) the process of generation of a Business Intelligence system starts with modeling the Business Process (step 10) followed by building the Businiess Intelligence System (step 15). This is followed by generating the Business Intelligence system (step 20) followed by an analysis of the Business process (step 25). The process concludes with correcting earlier assumptions about performance of the business process and increasing performance metrics and through a re-input of those metrics into the business process (step 30.) Statistical analysis and data mining techniques will be used to optimize the business process.

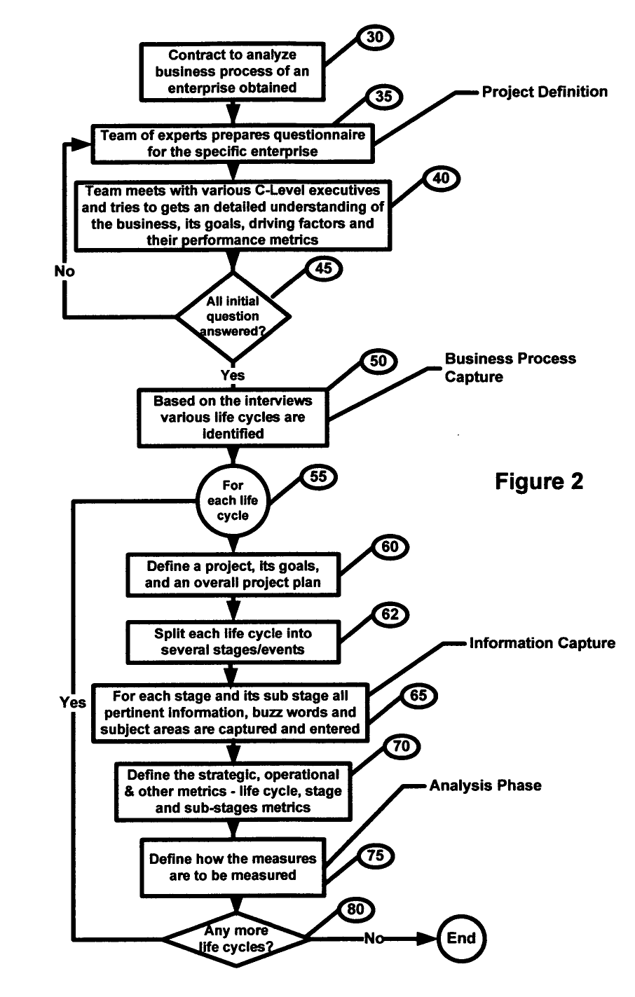

FIG. 2 is a flow chart illustrating the sequence of steps involved in modeling a business process towards the generation of a comprehensive Business Intelligence system.

Modeling

In accordance with a preferred embodiment of the present invention, a business process analysis starts with modeling the business processes. The modeling step allows a business analyst to capture the broad outline and procedures that govern what it is that a business does. Modeling allows integration of the regular tasks undertaken by a Business with the business processes through insight-driven actions. Modeling helps define business processes, process life cycles, stages, specific inputs and outputs, resources consumed, chronology of activities performed and the events that drive the overall process.

Business process modeling may affect more than one organizational unit. So modeling a business process requires well developed, user-friendly tools and interfaces to structure the business process. Moreover, business process modeling requires a business-centric approach and not a techno-centric view. The business process modeler should be designed to meet the business requirements of business users, but not IT stall.

In accordance with a preferred embodiment of the present invention. Modeler helps organizations visualize, analyze and improve business processes. A business process modeler provides business analysts and IT developers with an easy to use way to model their business value of IT solutions by allowing business analysts to tie corporate initiatives and goals to business requirements and processes. A modeler helps design a business process life cycle and stages, define overall metrics for the business process life cycle, define individual life cycle stage metrics, generate requirements documentation and develop applications to real-life organizations.

In accordance with a preferred embodiment of the present invention, the process of modeling a Business process comprises of several steps illustrated as follows. In step 30, a contract to analyze the business process of an enterprise is obtained. In step 35, a team of experts prepares questionnaire tailor made for the specific enterprise and its business process is prepared. In step 40, the team meets with various C-Level executives within the enterprise to obtain a detailed understanding of the business, its goals, driving factors and their performance metrics. Once the team's questions have been answered (step 45) and based on the output from these interviews various life cycles within the Business process are identified (step 50.) F, or each life cycle, modeling is done to define the project, its goals and an overall project plan (step 60.) In step 62, each business process lifecycle is split into several events or stages. In step 65, all business activities (stages) and their dependencies (sub stages) are input into the modeler. In step 70, for each stage and its sub stage all pertinent information, buzz words and subject areas are captured and entered. In step 75, the metrics to be measured and the type of measurement to be undertaken are defined (step 75.) If there are no more life cycles (step 80) the modeling process is concluded.

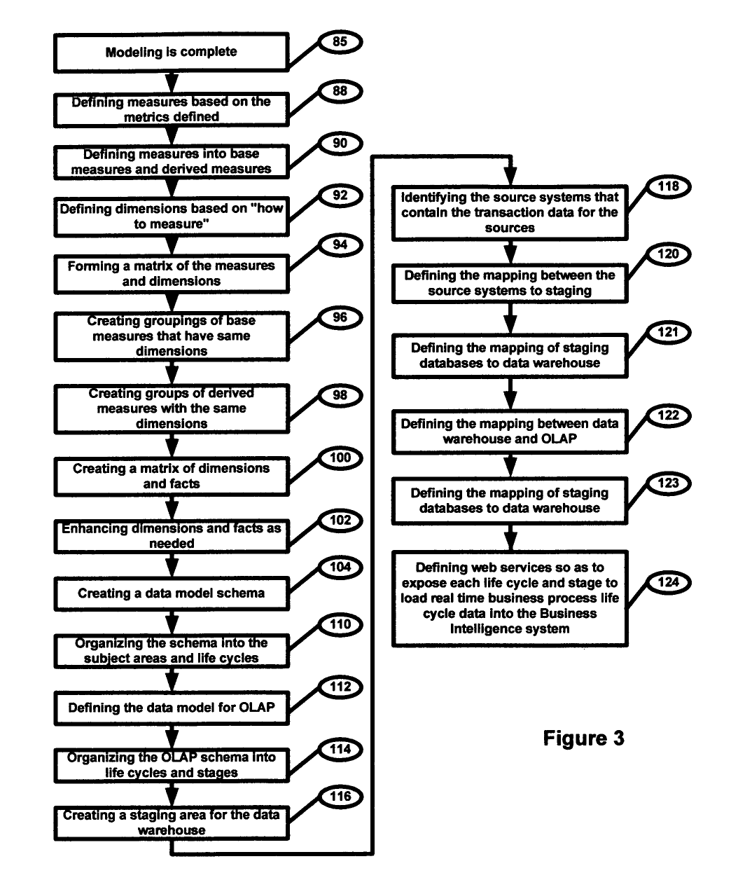

FIG. 3 is a flow chart illustrating the sequence of steps involved in translating a business process into building a comprehensive Business Intelligence system.

Once modeling is concluded (step 85), Business Intelligence architect defines the measures based on the metrics defined in model analysis (step 88.) In step 90, the measures are defined into base and derived measures. In step 92, Business Intelligence architect defines the dimensions based on “how to measure.” In step 94, a matrix of the measures and dimensions is formed. In step 96, groupings of base measures that have the same dimension are created. In step 98, groupings of derived measures that have the same dimension are created. In step 100, a matrix of dimensions and facts is created and are associated with the business process life cycle and stages. In step 102, dimensions and facts are enhanced as needed. In step 104, a data model schema is created. It would be known to those of ordinary skill in the art that the data model so created may be in any format including star or snowflake. In step 110, the schemas are organized into subject areas and life cycles. In step 112, the data model for the OLAP is defined. In step 114, the OLAP schema is organized into life cycles and stages. In step 116, a staging area for the data warehouse is created. In step 118, the source systems that contain the transaction data for the sources is identified. In step 120, the mapping between the source systems to staging is defined followed by a defining of the mapping of staging database to data warehouse (step 121.) In step 122, the mapping between data warehouse and OLAP is defined. In step 123, web services are defined so as to expose each life cycle and stage. In step 124, web services are defined to load real time business process life cycle data into the Business Intelligence system.

It will be known to those of ordinary skill in the art that based on the specific needs some of the steps can be by passed and a data warehouse created.

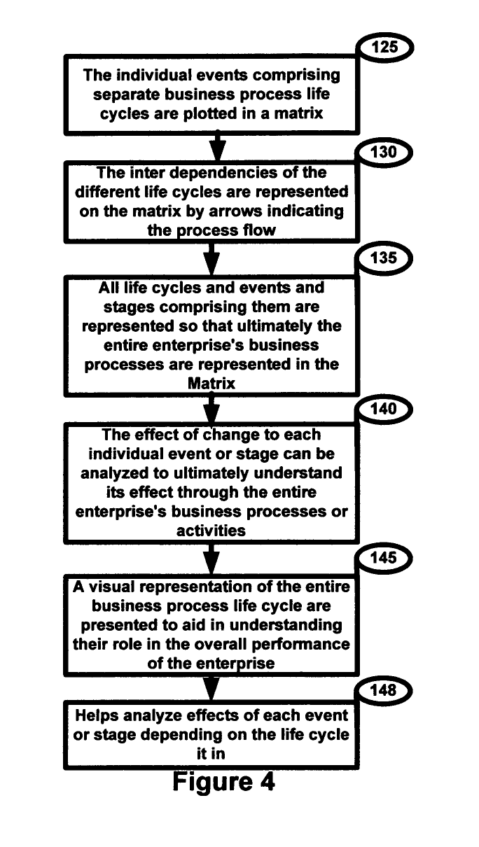

FIG. 4 is a flow chart illustrating the steps involved in formulating the matrix during the modeling phase in the generation of the Business Intelligence system.

In accordance with a preferred embodiment of the present invention, in step 125 the individual events comprising each business process lifecycle are plotted in a matrix. In step 130, the inter dependences of the different lifecycles are represented on the matrix by arrows indicating the process flow. In step 135, all lifecycles and events/stages comprising them are represented in the matrix so that ultimately the Business processes of the entire enterprise are represented in the matrix. In step 140, the effect of change to each event or stage can be analyzed to ultimately understand its effect through the processes of the entire enterprise. In step 145, a visual representation of the entire business process lifecycles are presented to users to aid in understanding the role of each event or stage in the overall performance of the business enterprise. This helps the users obtain more Business Intelligence pertaining to effects of each event or stage depending on the Business process lifecycle it is in (148.)

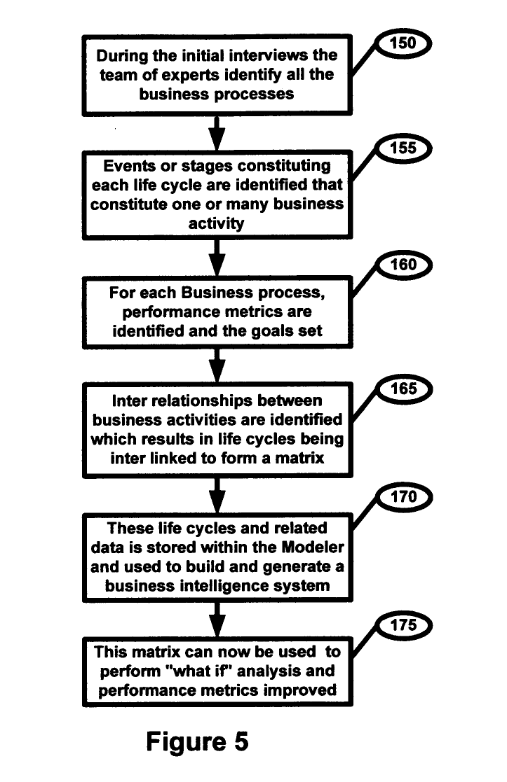

FIG. 5 is a flow chart representation of the series of steps followed during the modeling phase to capture information from executives at the enterprise, which in turn shapes the matrix. In step 150, during the initial interviews conducted with C-level executives at an enterprise, all the business process lifecycles are identified. In step 155, events or stages constituting each business process lifecycle are identified. In other words, each business process is split into numerous stages/events. In step 160, for each business process lifecycle performance metrics are identified and business goals are established. In step 165, interrelationships between lifecycles are identified which results in life cycles being interlinked to form a matrix. In step 170, these business process lifecycles and related data is stored within the modeler and used to build and generate the Business intelligence system. In step 175, the matrix is obtained which can be used to perform “what if” analysis and to improve the performance metrics set earlier.

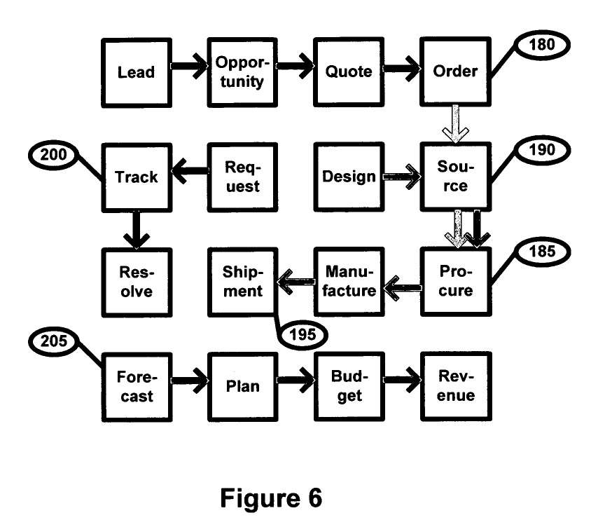

FIG. 6 is an illustration depicting the MATRIX methodology in a preferred embodiment of the present invention.

In accordance with a preferred embodiment of the present invention, as shown in FIG. 6, the first life cycle (180) being analyzed in the analysis of the overall business process is Lead-to-Order which is part of Customer relationship Management Life Cycle. The second lifecycle (185) is Order-to-Procure which is part of Supply Chain Management Life Cycle. The third lifecycle (190) being analyzed is Design-to-Source which is part of Production Management lifecycle. The fourth lifecycle (195) being analyzed is Procure-to-Shipment which is part of Supply Chain Management lifecycle.

The fifth lifecycle (200) is Request-to-Resolve which is part of Customer Support Management lifecycle. The sixth lifecycle (205) is Forecast-to-Revenue which is part of Financials Management lifecycle.

In accordance with a preferred embodiment of the present invention, the matrix methodology relates to taking a Business process and splitting it into smaller lifecycles, defining and identifying smaller stages within a lifecycle, and analyzing the way each event behaves depending on the lifecycle it is in. Thus, the MATRIX methodology relates to how an event or a stage behaves based on the life cycle it is part of. For instance when analyzing the event “Order” in the lifecycle Lead-to-Order, what the user is analyzing is different from what is being analyzed with regards to the event “Order” when it is analyzed as being part of the Order-to-Revenue lifecycle. The reason is that the former lifecycle takes into account events and/factors that take place prior to the order being booked and in the latter lifecycle the events/factors being analyzed are ones that occurred after the order had been booked.

Although the present invention has been particularly shown and described above with reference to specific embodiments, it is anticipated that alterations and modifications thereof will no doubt become apparels to those skilled in the art. It is therefore intended that the following claims be interpreted as covering all such alterations and modifications as fall within the true spirit and scope of the invention.

1. A method for modeling a Business Intelligence system comprising the steps of:
splitting each business process lifecycle within the overall business process into several events;
defining performance metrics and dimensions for said business process lifecycle;
plotting individual stages comprising said business process lifecycle on a matrix.

2. The method of claim 1, wherein said plotting of business process lifecycles on a matrix further comprises the steps of:
creating a “X” row for each business process lifecycle, wherein each cell in the row comprises of each stage in the lifecycles; and
creating a “Y” column for each business process lifecycle, wherein each cell in the column comprises of each stage in the lifecycle.

3. The method of claim 2, wherein said plotting provides a visual representation of all business process lifecycles within a business process enterprise and their interrelationships.

4. The method of claim 1, wherein said method enables users to identify overall effects of each stage or lifecycle on overall business process of an enterprise depending on the lifecycle it is considered part of.

5. The method of claim 1, wherein the step of modeling further comprises:
obtaining an understanding of the business process requirements;
identifying individual business process lifecycles within the business process;
adding stages and sub stages in lifecycles by capturing information related to each stage and sub stage; and
analyzing the information captured.

6. The method of claim 5, wherein the step of obtaining an understanding of the business process requirements further comprises defining a project, defining goals of the project, and defining project plan.

7. The method of claim 5, wherein the information captured is in the form of buzzwords, subject areas and other pertinent information related to the business process.

8. The method of claim 7, wherein the information captured may be information such as cycle times, backlog, turn around time by suppliers, and age of shipment.

9. The method of claim 5, wherein the step of analyzing further comprises:
defining dimensions and facts to be measured and type of measurement to be undertaken.

10. A system for modeling a Business Intelligence system, said system comprising:
a project module for obtaining an understanding of the business process requirements and identifying lifecycles within the business process;
a Business Process module for identifying lifecycles within the business process and for splitting the business process into several events;
an information capture module for capturing data inputs;
an analysis module for analyzing the information captured;
a model analyzer to analyze requirements of the business process as generated by the modeler;
a source module to identify the source of various data inputs;
a staging module for preparing data for loading into data warehouse;
a data warehouse module to store data;
an OLAP module to generate Business information from the data; and web service applications module to distribute data from one application to the other.
